(19) United States
(12) Patent Application Publication
(10) Pub. No.: US 2017/0309108 A1
(43) Pub. Date: Oct. 26, 2017

(54) NETWORK-IMPLEMENTED METHODS AND SYSTEMS FOR AUTHENTICATING A CHECK

(71) Applicants: Alex Sadovsky, Toronto (CA); Alexey Plotkin, Thornhill (CA)

(72) Inventors: Alex Sadovsky, Toronto (CA); Alexey Plotkin, Thornhill (CA)

(21) Appl. No.: 15/644,454

(22) Filed: Jul. 7, 2017

Related U.S. Application Data
(63) Continuation-in-part of application No. 14/715,525, filed on May 18, 2015.

(51) Int. Cl. G07D 7/202; G06K 9/62; G07D 7/20; G06K 9/18

(52) U.S. Cl. CPC G07D 7/202; G07D 7/2016; G06K 9/186; G06K 9/6212; G06K 9/6215

(57) ABSTRACT

The disclosure relates generally to checks and other negotiable financial instruments and particularly to mitigating exposure to financial fraud. Specifically, the disclosure relates to systems and methods of authenticating checks issued by a first entity for the benefit of a third party.

### CROSS REFERENCE TO RELATED APPLICATIONS

This application is a continuation-in-part of co-pending U.S. application Ser. No. 14/715,525 filed May 18, 2015, which claims priority from now expired provisional application No. 61/994,940, filed May 18, 2014, both which are incorporated herein by reference in their entirety.

### COPYRIGHT NOTICE

A portion of the disclosure hereinbelow contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND

The disclosure is directed generally to negotiated financial instruments and particularly to mitigating exposure to financial fraud. Specifically, the disclosure is directed to systems and methods of authenticating checks issued by a first entity for the benefit of a third party.

Financial Institutions (FI), and clients (retail, banking, individuals, small business clients, big corporations, government and alike) are faced with increased exposure to financial losses and fraud on a daily basis, with transactions associated with acceptance and negotiating of Money Orders, Drafts, Certified Checks, Cashier Checks, Governmental refund checks, Government (local and other) payroll checks, social security checks, welfare and pension checks, retail individual checks, business checks and the like, (referred to herein as “check” or interchangeably, “item(s)”, or 'FCI).

The aforementioned negotiated financial paper instruments can hold a unique product design and be marketable in the commercial, financial and banking systems. In various embodiments, the check to be authenticated is a payroll check being cashed by an employee, a personal check, a corporate check, company insurance refund check, a government check, such as a tax refund check, Social Security check, payroll check, or other government-issued check, a traveler's check, bank check, official check, convenience check, money order, second-party check or other obligation, third-party check, value-carrying paper, or other type of cashable financial instrument.

Some checks such as drafts, cashier's checks, money order, when purchased, can be fully paid for by the purchaser at the time of transaction, and hence referred to as “cleared funds” or “guaranteed funds”, because the bank, rather than the purchaser, is responsible for paying the amount. Similarly, certified checks (any check issued from retail or business account), are also treated as guaranteed funds when bank certifies and guarantees that funding are available to clear the amount written on the check. Many consumers and businesses favor these instruments as it gives the recipient comfort and security in knowing the funds are “guaranteed” by the bank and there is immediate access to the funds as needed, without any ‘hold’ periods at time of deposit or cashing.

However, for the past several years, the nature of these instruments has been posing an increased risk for many financial institutions. Many banks are continuously faced with altered, counterfeit or fraudulent items with no possibility to verify authenticity of the item prior to its' clearing′ overnight. Even with overnight ‘clearing’ procedure, banks may be potentially faced with financial losses as it may not be immediately known that an item in question is fraudulent. The aforementioned financial instruments are most favored in the criminal sphere, due to the “guaranteed” features and trust factor by the banks.

Some financial institutions have stopped verifying these items by phone, fax or e-mail altogether, due to numerous human errors resulting in substantial financial losses and legal liability exposure. As such, due to increased risks and lack of reliable authentication tools for the items, banks are forced to freeze access to these funds upon deposit for a few business days (sometimes up to 4 days), until a formal ‘clearing’ and some form of authentication can take place. This process can be a major inconvenience, a sore point to customers and a major risk factor for banks often resulting in significant financial losses.

Likewise, all businesses are typically faced with some level of fraud associated with checks and similar negotiable instruments. Financial institutions offer complicated fraud mitigation and or protection schemes to businesses that require very complex operation and relatively short window of opportunity in which the fraud could be stopped. Business clients, small and large, (herein referred to interchangeably as “Business Issuer”) can therefore be faced with significant fraud and risk associated with company business checks issued to suppliers, vendors, employees, government and the like. Many Business Issuers are targeted by cons for issued business checks as part of significant fraud schemes. The business checks, often intercepted by mail and altered for amounts, payee, dates and others—cause significant financial losses for the businesses.

Although digital forms of payments solutions are available by financial institutions, majority of Business Issuers still prefer to use paper business checks as it allows to extend cash flow (checks in the mail allow businesses to extend cash flow management, along with substantial cost savings). Financial institutions who understand consumer preferences have created service solutions for big commercial customers. The solutions offer complicated check fraud mitigation services to largest commercial customers such as insurance company for a very significant cost amount per check. Current in market solution offers a very complex structure and manual processes that is very expensive with minimally proved effectiveness due to short window to return suspicious items and mandatory manual interactions with the business issuer.

In addition, government agencies and its designated affiliates (federal, provincial, state, municipal, welfare and alike) that issue/print government checks (welfare, tax refunds, social security and alike) equally face significant fraud with such negotiable instruments (in other words checks) due to “guaranteed” treatment and status of funds, as well as cashing options in the financial institutions/external terminals such as post office and/or ATMs. The items (or extorted, etc.) are often stolen and altered for higher amounts and presented for immediate cashing negotiations, hence committing fraud and financial losses to parties. Financial institutions and others that cash government checks do not have the option to validate the true authenticity of the item and as such, fall victims to fraud. Customers, in many cases experience poor client experience and have limited access to funds due to imposed holds on funds. In many cases, recipients of such government checks are in dire need of these funds for daily survivor yet historical losses around cashing such items cost financial institutions and those accepting the items for negotiations significant fraud losses.

Accordingly, there is a need for providing financial institutions with a rapid verification and authentication (FIAV) systems and methods that can be used by large financial institutions, cashing centers or other interested parties, which can also be used effectively by independent business such as dealerships and alike (accepting check as form of payment) to validate authenticity of items prior to transaction on the spot. Especially guarantied funds like money order, bank checks, certified checks, etc.

Additionally, retail consumers who issue personal checks are exposed to fraud and often fall victims to it as well. In many documented cases, retail checks have been intercepted, altered and negotiated causing the issuer significant losses of money. The issuer, unless controls the transactions on account closely does not have any alert options on suspicions transactions as the bank does not ever know the original intended issued check amount and details. As such, a system that shares with the bank details of originally issued item helps catch fraud and suspicious transactions upon processing. Fraud loses can be significantly minimized with proposed and claimed authentication algorithm.

### SUMMARY

In an embodiment, provided herein, is a system for authentication and verification of a checks comprising: a first data access module comprising at least one imaging subsystem; an image processing module; a second data access module comprising at least one imaging subsystem; a data processing module comprising, wherein the second data access module is temporospatially separated (or in other words, is in a different location whereby the scan is performed not at the same time) the first data access module: a memory; a management server; and a processor in communication with the memory, the first data access module, the second data access module, the management server, and the image processing module, wherein the processor is configured to: receive on the management sever a first image corresponding to a first check from the first data access module; receive on the management server, a second image corresponding to the second check from the second data access module; partition the first image into a plurality of fields in the management server; partition the second image into the same plurality of fields in the management server; compare the plurality of fields of the second image to the plurality of fields of the first check image; determine the degree of similarity between the first image and the second image; and if the degree of similarity is above a predetermined value, provide an authentication indicia to the second data access module, otherwise provide an indicia of a lack of authenticity.

In another embodiment, provided herein is a method of authenticating a check, comprising: receiving a first image corresponding to a first check from a first data module; receiving a second image corresponding to a second check from a second data access module; partitioning the first image into a plurality of fields; partitioning the second image into the same plurality of fields; comparing the plurality of fields of the second image to the plurality of fields of the first check image in order to determine a level of similarity between the second image and the first image; determining the degree of similarity between the second image and the first image; and if the degree of similarity is above a predetermined threshold value, providing an authentication indicia to the second data access module.

In yet another embodiment, provided herein is a non-transitory computer-readable medium comprising computer-readable instructions for authenticating a check, said computer-readable instructions configured for causing a processor to: receive a first image corresponding to a first financial instrument from a first data module; receive a second image corresponding to a second financial instrument from a second data access module; partition the first image into a plurality of fields; partition the second image into the same plurality of fields; compare the plurality of fields of the second image to the plurality of fields of the first check image in order to determine a level of similarity between the second image and the first image; determine the degree of similarity between the first image and the second image; and if the degree of similarity is above a predetermined threshold value, provide an authentication indicia to the second data access module.

### BRIEF DESCRIPTION OF THE DRAWINGS

The features of the systems and methods of authenticating paper financial check instruments described will become apparent from the following detailed description when read in conjunction with the drawings, which are exemplary, not limiting, and in which:

FIG. 1, shows a block diagram of the paper financial instrument authentication and/or verification (FIAV) system architecture;

FIG. 2, shows a block diagram of government and big corporate image and data file upload into FIAV system;

FIG. 3, shows a block diagram of end user paper FIAV system station;

FIG. 4, illustrates a flow chart describing image capture of the financial check instrument by the institutional issuer;

FIG. 5, illustrates a flow chart describing image capture of the financial check instrument by the institutional payor and comparison validation;

FIG. 6, illustrates a flow chart describing image capture of financial check instrument by e.g., business or retail issuer;

FIG. 7, illustrates a flow chart describing file upload with images and/or image data of financial check instruments by e.g., government and/or big corporate business;

FIG. 8, illustrates a flow chart describing image capture of the financial check instruments by e.g., by business or retail clients payor and comparison validation

FIG. 9, illustrates a flow chart describing image and or data file upload of all check deposits by non-participating FI (FIs who do not use FIAV system to authenticate checks) the financial check instrument into FIAV System

FIG. 10, illustrates a flow chart describing image capture of the financial check instrument by ATM and comparison validation;

FIG. 11, illustrates an embodiment of the verification and authentication algorithm of a financial instrument by institutional entity with the ASP; and

FIG. 12, illustrates an embodiment of the verification and authentication algorithm of a financial check instrument by any entity without MICR magnetic reader capabilities with the ASP.

While the disclosure is amenable to various modifications and alternative forms, specifics thereof have been shown by way of example in the drawings and will be further described in detail herein below. It should be understood, however, that the intention is not to limit the disclosure to the particular embodiments described. On the contrary, the intention is to cover all modifications, equivalents, and alternatives.

### DETAILED DESCRIPTION

The disclosure relates in one embodiment to financial instruments and particularly to mitigating exposure to financial fraud. In another embodiment, the disclosure relates to systems and methods of authenticating check issued by a first entity for the benefit of a third party.

In an embodiment, the authentication service provider (ASP) can provide innovative solution that allows banks and other financial institutions to substantially reduce risk and fraud associated with financial instruments before depositing them in majority cases into an account and assuming any financial or operational risk or liability. The solution is based in an embodiment on a new and unique processes that can involve an algorithm that works together with a check scanner, ATM scanner, mobile phone camera, home desktop scanner, Optical Character Recognition (OCR), Intelligent Character Recognition (ICR), Image Mapping Comparison, and Magnetic Ink Character Recognition (MICR) to validate the authenticity of the item. After the item is scanned, the system can advise the bank (via software messaging), whether that item is secured (in other words, authentic), and can be deposited with no assumed risk, or conversely warns that the item is fraudulent.

The systems and methods provided herein are configured enable business customers, retail customers and government offices that issue checks to reduce risk and fraud associated with their own issued checks and other financial instruments, prior to their clearance, or in some cases immediately after the clearing. Accordingly, disclosed herein are embodiment of business processes that utilize, inter-alia, an algorithm that works together with a check scanner or smartphone camera (or other image capturing devices), Optical Character Recognition (OCR) subsystems, Intelligent Character Recognition (ICR) subsystems, Image Mapping and Comparison subsystems, and Magnetic Ink Character Recognition (MICR) subsystems to validate the authenticity of the check. In an embodiment, After the item is captured via scanner, smartphone camera or other form of image capturing, or by receiving the check data from the data file, the receiving system can be configured to advise a financial institution (via, for example, on screen messaging), whether that item is safe and can be deposited with no assumed risk, or warns issuing and negotiating customer and or FI of possibility of fraudulent check(s).

The systems and methods can therefore be configured for protecting and minimizing the business owners from exposure and vulnerability to check fraud; and provide corporate clients such as, for example, car dealerships, check cashing businesses and other corporates to validate and authenticate the checks they receive. Accordingly and in an embodiment, provided herein is a system for authentication and verification of a financial check instrument comprising: a first data access module associated with a first user's client device (in other words, a first network node), comprising at least one imaging subsystem; an image processing module; a second data access module associated with a second user's client device (e.g., a second network node), comprising at least one imaging subsystem a data processing module comprising: a memory; and a backend management server having thereon a processor in communication with the memory, the first data access module, the second data access module, and the image processing module, wherein the processor is configured to: receive a first image corresponding to a first financial instrument from the first data module; receive a second image corresponding to the second data access module; partition the first image into a plurality of fields; partition the second image into the same plurality of fields; compare the plurality of fields of the second image to the plurality of fields of the first check image in order to determine a level of similarity between the second image and the first image; determine the degree of similarity between the first image and the second image; and if the degree of similarity is above a predetermined value, provide an authentication indicia to the second user associated with the second data access module.

It is to be further appreciated that the use of the term client and server is for clarity in specifying who receives a service (the client) and who performs the service (the server). No hierarchy is implied unless explicitly stated. In other words, for security reasons and to minimize the processing power required from the client network nodes, the parsing of the image(s) to the various fields is performed on the server side. Furthermore, it is noted that as part as providing the indicia of authenticity (or lack thereof), no files are transported through the network, ONLY the indication that the second (or third and so on) image has been verified and found to have similarity at a level that authenticates is based on the second user predetermined similarity threshold. No image files are transferred back to any user and all images, once uploaded to the backend management server can be maintained on the server either as an image, or in other embodiments, as the image data parsed to the determined fields.

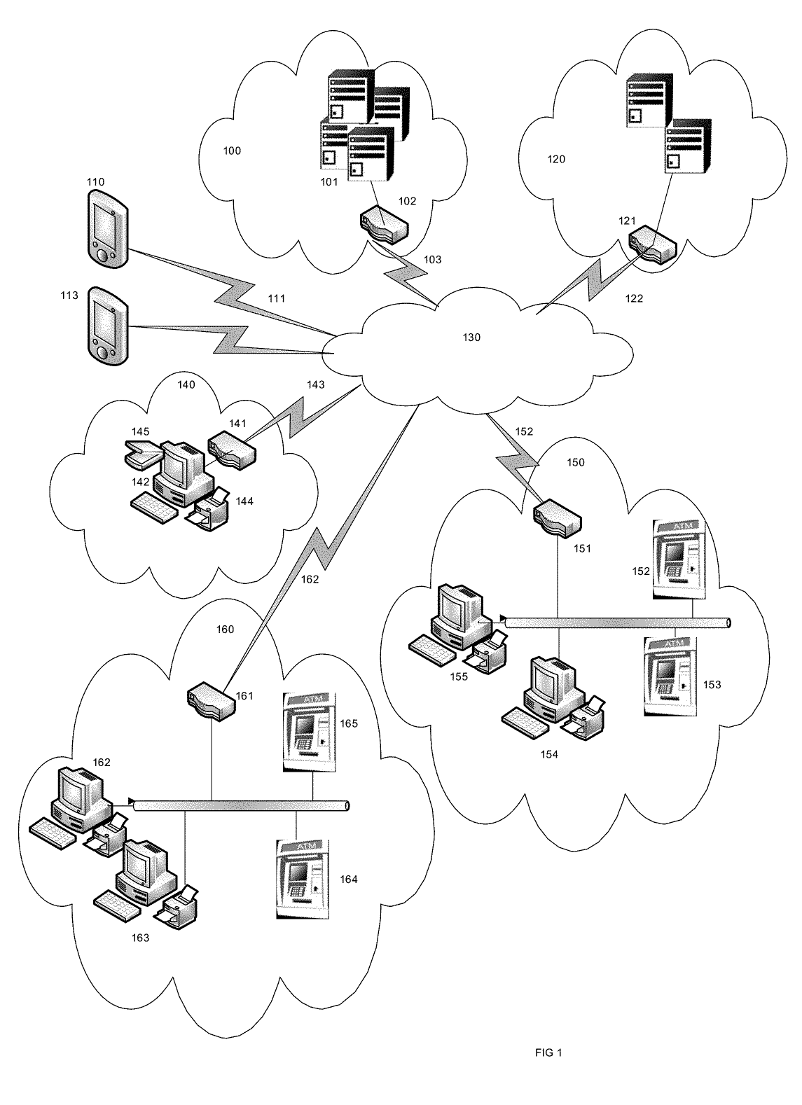

In an embodiment, the indicia transmitted to the second (third, fourth, and so on . . . ) data access module(s) can be various types of machine-readable indicia, for example, barcodes, QR codes, matrix codes, 1D codes, and 2D codes, machine-readable characters, warning symbols, messaging, or a combination thereof. The indicia are typically graphical representations of information (e.g., data) such as, for example deposited check(s) number(s), transaction tracking numbers, or personnel identification numbers. In an embodiment, the indicia transmitted by the backend management server to the first and/or second data access modules (and any other data access module), is a message that is read and rendered by a dedicated software application residing on a memory of the first and/or second data access module(s) (e.g., 140, 150, 160, see e.g., FIG. 1). The message protocol can be, for example, eXtensible Markup Language (“XML”), a hypertext markup language (“HTML”), a hypertext markup language 5 (“HTML5”), Hypertext Transfer Protocol (HTTP), Hypertext Transfer Protocol Secure (HTTPS), Extensible Messaging and Presence Protocol (XMPP), Java Message Service (JMS), Simple Object Access Protocol (SOAP), and a combination of the foregoing messaging between clients and servers.

In certain embodiments, users in, for example, large organizations or governmental departments (e.g., tax authorities, or social security administration) may send large data files to the backend management server used in the methods and systems described herein. These data files can comprise check images and/or metadata on recipients, signature samples, and other identifying information including check amounts and dates. The data files can be used during the authentication process once the image is parsed and before, for example before a comparison is made between the MICR and the OCR, the presence of previously deposited instances and the like. For example, a third scanning/presentation of the same check, either as different temporospatial event, or at the same location, but at different times—thus triggering an alert message of, for example; “The check has been previously presented”.

The term “subsystem” is used in an embodiment, to include both the hardware and firmware components that accomplish these functions. Likewise, and in another embodiments, the term “module” with respect to a system may refer to a hardware component of the system, a software component of the system, or a component of the system that includes both hardware and software (application and middleware).

In an embodiment, the systems and methods described herein allow banks to substantially minimize fraud associated with aforementioned financial instruments by utilizing a unique algorithm and check scanners. The technology allows, for example, the receiving branch (or ATM, tablet, phablet, PDA, Smartphone, Computer, e.g., the second data access module) to validate authenticity of items prior to depositing, based on magnitude of different parameters that are captured and later analyzed by the system when the item is issued and verified. As such, upon issue of any of the financial items mentioned, the bank scans them using the scanner into a highly secured database. Numerous characteristics are captured by the software and stored. For a bank that is negotiating a paper item, a quick scan using their scanner and software resident on the management server can then determine and then confirm authenticity of the item (or conversely, raise alarms over the possible lack of authenticity), relative to its original condition at time of issue.

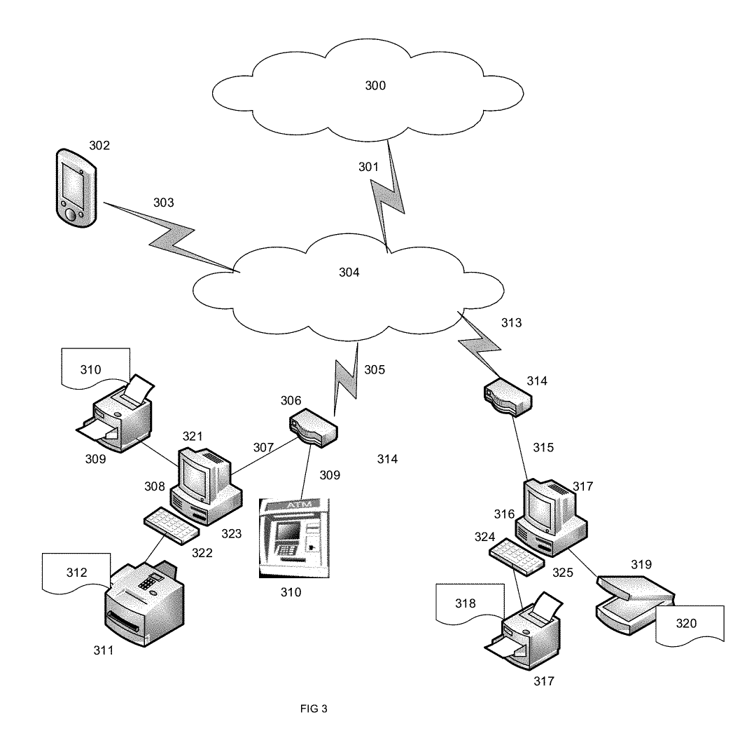

As illustrated in FIG. 3 the issuing or paying user station can comprise, for example, a Check scanner 309 (imaging subsystem) optionally with dual-sided scanning capabilities for complete image capture of both sides of the check with MICR, (with resolution of no less than 200 dpi), computer 308, printer 311, standard monitor 321, pointing device 323 (not shown) and keyboard 322, and secured connection 305 to a system server 300 (in other words, backend management server) and optionally a secured connection to an automatic teller machine 310. It also can comprise regular office scanner 320 and or mobile device that allows image capturing and secure connection 303 (including through the bank RDC app).

In an embodiment and as illustrated in FIG. 1, data access module 140, just receives 143, 111 the image (e.g., from dedicated check scanner 144, regular scanner 145, or through network 130, from handheld device 110, or 113) and uploads 103 the first scanned image to backend management server 101. Processing module in server 101 can be configured to parse the image into predetermined fields, retrieve data from the uploaded scanned check image, send back 143 to first data access module 140 for first user confirmation. After receiving a second scanned image from a second data access module 150, or 160 that is in electronic communication with backend management server 101, via, for example, WAN 130, the system can then be configured to compare the two images (temporospatially separated) and provide second (or third and consecutive) users associated with second access modules e.g., 150, 160, with authentication results (indicia, e.g., a binary file). When each check is scanned, only that check image(s) is transferred and uploaded 143, 111 into management server(s) 101 and is likewise parsed by the server image processing module. All function of breaking/parsing the image into fields and comparison is configured to take place on backend management server 101, per image uploaded. In an embodiment, computer 142 and computer(s) 162/155 are not in the same building, and/or not on the same LAN, and/or not constitute the same WAN node.

As used herein, the term “node” refers to any computer system, device, or process that is uniquely addressable, or otherwise uniquely identifiable, in a network and that is operable to communicate with other nodes in the network. For example, a node may be a personal computer, a server computer, a hand-held or laptop device, a tablet device, a multiprocessor system, a microprocessor-based system, a set top box, a consumer electronic device, a network PC, a minicomputer, a mainframe computer, a distributed computing environment that includes any of the above systems or devices, or the like. An example of a network node 140, in the form of a computer system 142, regular scanner 145, dedicated check scanner 144, and network switch 141 is set forth with respect to FIG. 1.

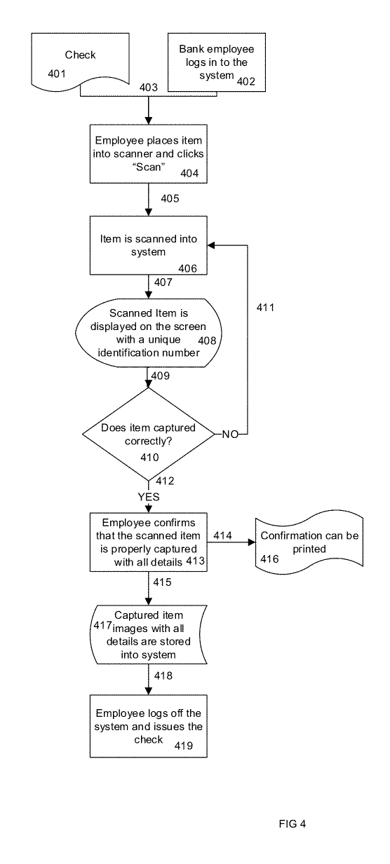

In an embodiment, the software can be based on customized algorithms that utilize Optical Character Recognition (OCR), Intelligent Character Recognition (ICR), Image Mapping and Comparison, and Magnetic Ink Character Recognition technologies. As illustrated in FIG. 4, when a bank employee (user) logs into the system 402, two main options are provided; “Register Item” (pre issuance) or “Verify Item” (e.g., deposit, or pre-payment FCI). With the “Register Item” option, a teller places the check 401 into the scanner 404 and clicks the “Scan” button. The check passes through the scanner and once uploaded to the (backend) management server, the image processing module partitions the captured image to key areas (fields) of check 401. The fields can be, for example, a magnetic ink character recognition (MICR) line, Overall image as a whole, Date, Serial number, All signatures, Payee Name, Amount CAR/LAR, Issuing bank and branch details, Protectograph and magnetic ink values, hand written or printed item value. Partitioned fields are then transmitted back to the data access module and displayed on the screen with unique identification numbers to the user 408. The check parameters are being captured and stored with relevant data into a database on a secure server in electronic communication with the backend management server. A message box appears to let the user know that the system captured the check 401 correctly and successfully uploaded them to the system/server 417.

It is noted, that as used herein, the term ‘module’, refers in an embodiment to, a software or hardware component, such as a Field Programmable Gate-Array (FPGA) or Application-Specific Integrated Circuit (ASIC), which performs certain tasks. A module may therefore be configured to reside on the addressable storage medium (e.g., backend management server 101 in FIG. 1) and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Also illustrated in FIG. 4, various confirmation steps are also incorporated into the process, such as, for example, Employee (or first user) 402 can confirm that the scanned item is properly captured with all pertinent details 410, and once scanned, the captured image of check 401, is securely stored on the Authentication Service Provider's management server 300.

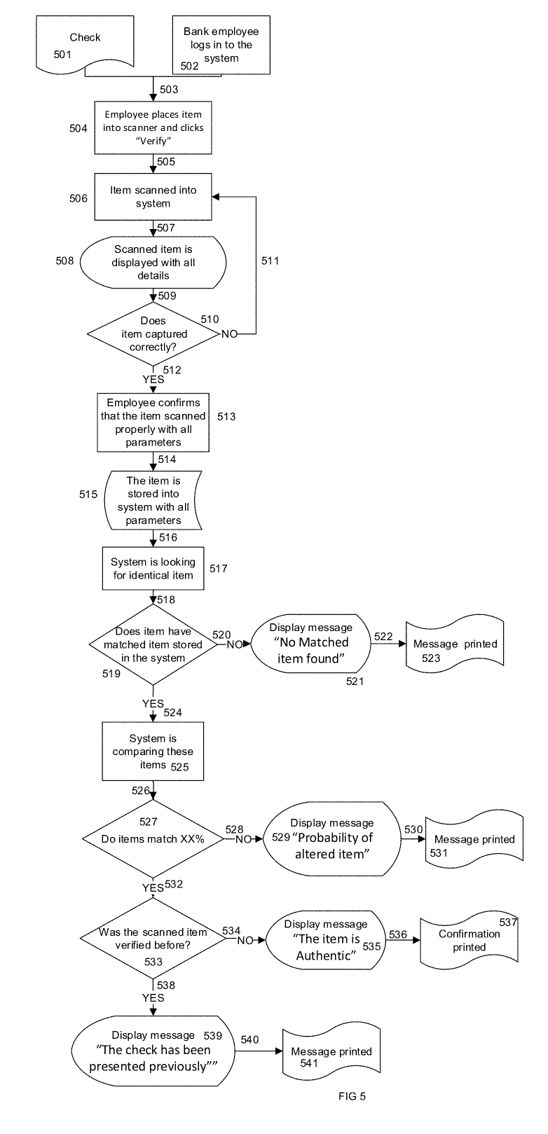

As illustrated in FIG. 5, and before payment, the user in the second data access module (user station, see e.g., FIG. 3), scans check(s) 501 for validation, he/she will click “verify item” and put the item through for scanning 504. As the item is being scanned by the system 506, all the attributes are being recognized, mapped and searched in the database for a match 517. The following messages and their associated definitions can appear in the message box based on authentication results:

Authentic Item 535 (indication is provided to the user)=a match has been found in the system with no previous authentication attempts 533. There is no reason to believe that the item was altered 532 in any form or fashion. Safe to deposit without hesitation of fraud.

No Match Found 520 (a different indication is provided to the user)=no matching item has been found in the system (item may have not been scanned into the database by issuing branch) or the check wasn't issued by the participating FI (See e.g., FIG. 4).

Possibly Altered Item 528—The key attributes and parameters match, however, the item does not match in some aspects to the originally issued item (in other words, either first scanned check image, or corresponding to data uploaded to backend ASP's management server 300). Deposit at own discretion, or as an “at risk” deposit. (indicated by, for example, pre-selected font color, additional warning label, etc.).

Similarly, check has been presented previously 539 (another indication is provided to the user)=match has been found in the system; however, a different financial institution has already scanned the item once or more. Depositing branch is to be cautious to avoid multiple deposits with one item.

Bank employee (e.g., end user) can then print the confirmation/message (523, 531, 537, 541) along with or without the originally scanned image, with a unique confirmation number and item details at the time of scan

As also shown in FIG. 5, several decision points can be incorporated into the authentication and or validation process of the image captured in the second data access module (see e.g., 317, FIG. 3). These include bifurcation of the process based on whether or not the image matches any image stored on the (ASP's backend management) server 300 memory 524; if a match exists and following a comparison by the data processing module 525, whether or not the plurality of fields identified and partitioned in the first image are identical to the plurality of fields identified and partitioned in the second image 501; and if identical, whether or not the first image (see FIG. 4, 401) has already gone an authentication/verification process 517 by another end user 502 at another location and has therefore been paid to the holder. In other words, providing at least a reasonable, contemporaneous evaluation on whether or not the financial instrument being verified can be a replicated item.

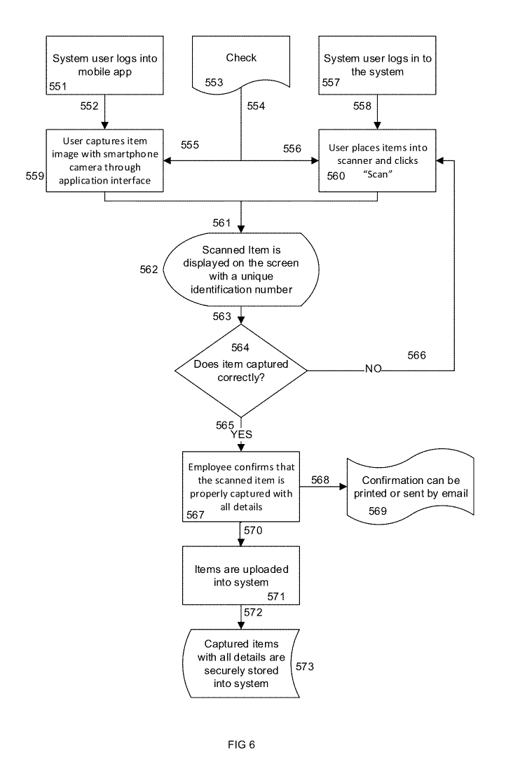

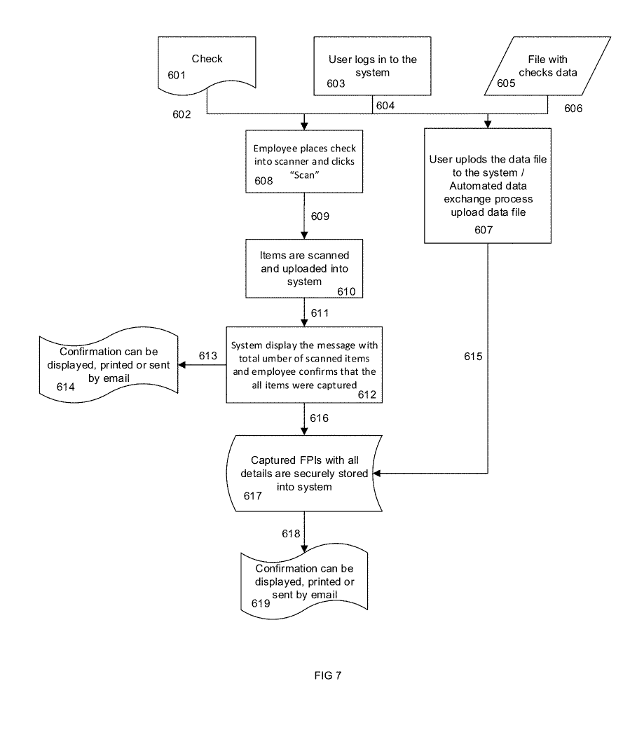

Similar to an institution, the first data access module (see e.g., computer 142, FIG. 1) can be a business and retail user that can issue checks to various payees such as suppliers, vendors, capital expenditure projects, taxes, individuals and the like. As illustrated in FIG. 6, when a business and retail user 551/557 issues a check, 553 the first image of the check can be captured using either dedicated check scanner 560 comprised in the first data access module (see e.g., 317, FIG. 3), an office scanner (see e.g., 319 FIG. 3), in electronic communication with a computer (702, FIG. 7) or a PDA 559 (see e.g., 302, FIG. 3). in further electronic communication with backend management server (300). At which point, the scanned first check image 562 (e.g., an issued check) is uploaded 305 (e.g., through WAN network) to the ASP's system 571, using the data processing module, in combination with the image processing module, the first image of financial instrument 553 is partitioned to a plurality of fields as described herein, and the data is displayed 562 to user 551/557, whereupon end user (e.g., employee) can confirm whether or not the first image was captured properly 567 (in other words, verifying the first image and then validating it) and optionally print that confirmation 568. Once confirmed, the scanned first image and its partitioned fields with their unique identification number (UID) are stored 573 on the ASP's server for later authentication purposes 669.

Similar to an institution, the first data access module can be a big business and/or government user that can issue business and government checks to various payees such as suppliers, vendors, capital expenditure projects, taxes, individuals and the like as described herein. As well as government checks in a form of personal assistance checks, social security, tax refunds and alike. As illustrated in FIG. 7, when a business or government user 603 issues a business or government check 601, 602 they can capture the first image 608 of the check using either dedicated check scanner (see e.g., 319, FIG. 3) comprised in the first data access module (see e.g., 317, FIG. 3), an office scanner (see e.g., 319 FIG. 3), in wired or wireless communication 325 with a computer (317, FIG. 3) or a PDA (see e.g., 302, FIG. 3), which can be in electronic communication with the management server. The term “electronic communication” means that one or more components of, for example, check scanner 608 described herein, are in wired or wireless communication or internet communication so that electronic signals and information can be exchanged between the components.

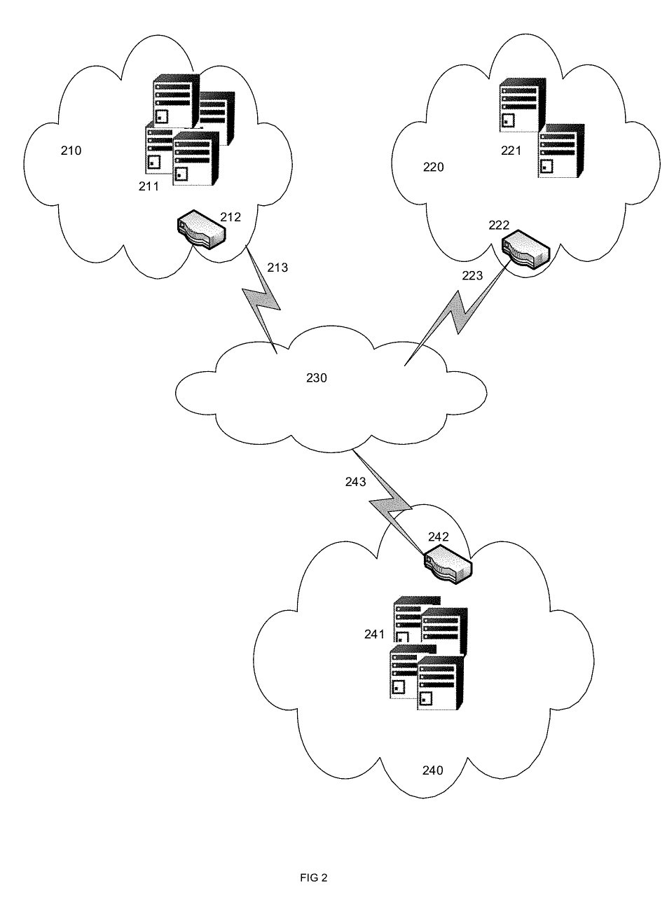

At which point, the scanned first image of financial instrument 610 (e.g., an issued business or government check) is uploaded (e.g., through e.g., wide area network or WAN secured network) to the ASP's system 617, using the data processing module, in combination with the image processing module, the first image of financial instrument 601 is partitioned on management server 300 (see e.g., FIG. 1) to a plurality of fields as described herein, and the data is displayed 612 to user 603, whereupon authorized end user (e.g., employee) can confirm whether or not the first image was captured properly (in other words, verifying the first image and then validating it) and optionally print that confirmation 614. Likewise, it is possible for big corporation and government issued checks to be uploaded 607 via a data file 605 with metadata containing details for each item directly from company or government servers (see e.g. 221, FIG. 2) into ASP's systems (see e.g. 211, FIG. 2) through internet (see 230, FIG. 2) utilizing secure data exchange protocol (e.g sFTP) or through secured network (e.g. VPN—Virtual Private Network). When such option is exercised 607, confirmation of a successful upload is displayed 617 and can be kept for record keeping 619. When image scanning option is exercised 608, the system displays confirmation of all scanned items and quantities in 612 for confirmation and future record keeping 614. Once confirmed, the scanned first image with relevant data with their unique identification numbers (UID) are stored 617 at the ASP's server for later authentication purposes 669.

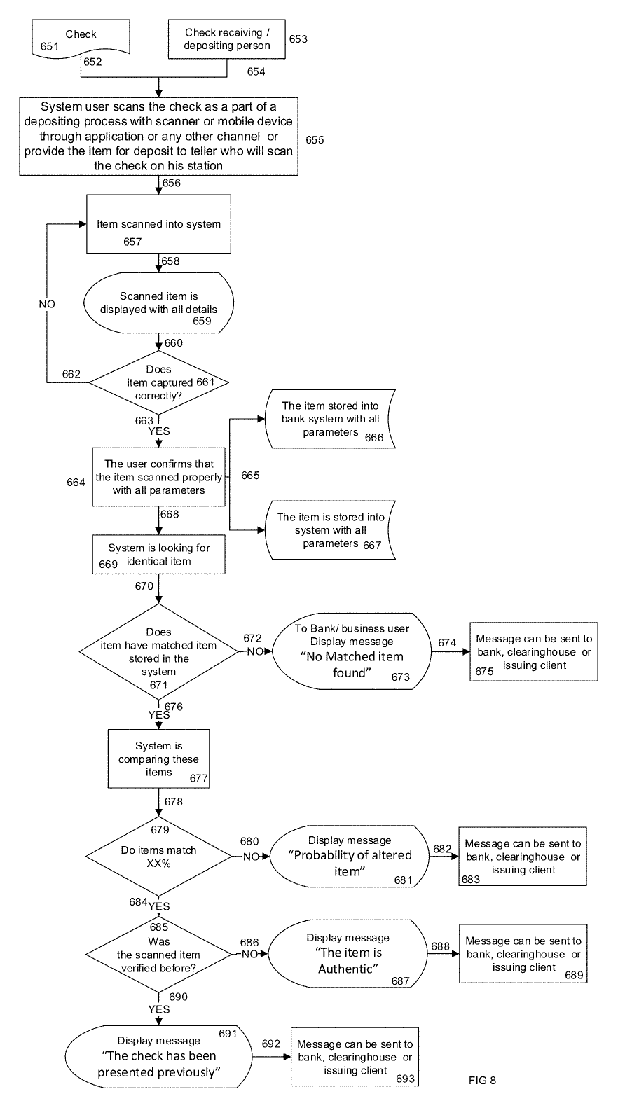

Similarly, authentication of all received checks is illustrated in FIG. 8. As illustrated, an end user 653 and or 655 in the second data access module (user station 317, see e.g., FIG. 3) can log on 313 to the ASP's system 304 and capture 320 (e.g., using scanner 319) the second image 655 of the check 651.

At which point, the scanned second image of check 651 (e.g., the business, government, big corporation, draft, certified check, money order, cashier check, or personal, check sought to be deposited or cashed) is uploaded (e.g., through WAN network) to the ASP's system 657, using the data processing module, in combination with the image processing module, the second image of the check 651 is partitioned to a plurality of fields as described herein, and the data is displayed 659 to user 653. Similar to the issuing process in the first data access module, end user 653 (e.g., employee), can confirm whether or not the second image of paper financial instrument 651 was captured properly 661 (in other words, verifying the second image and then validating it) 664. Once confirmed, the scanned second image and its partitioned fields with their unique identification number (UID) are stored on the ASP's server for comparison and authentication purposes 667. Using UID from the second image, the ASP's system, utilizing the data processing module, the ASP's system can search 669 for a verified and validated matching image of a check (e.g., 553, see e.g., FIG. 6).

Once the ASP's data processing module (residing on the backend management server, completes the search, various sequential decision points can be employed to authenticate the second check 651. For example, the system queries whether or not the image and partitioned fields matches any image or partitioned fields stored on the data processing modules' memory 671, else, the system can display a message that no matching paper item was found 672, which can then be printed 675; if a match exists and following a comparison by the data processing module 676, whether or not the plurality of fields identified and partitioned in the first image are identical to the plurality of fields identified and partitioned in the second image 651, else, the system can display a message “probability of altered item” 681, which can then be printed 689.

If identical match is found, whether or not the first image (see FIG. 8) has already gone through an authentication/verification process 677 by another end user 653 and or 655 at another location (e.g., second data access point, or user station) and has therefore been paid to the holder. In other words, providing at least a reasonable evaluation and/or warning as to whether or not the financial instrument being verified for authentication to avoid a check being passed through the system twice at different instances 691. If the item has been verified by a second data access module, the system can be configured to send a message to that effect 693, else, the system can display a message that the paper item is authentic 687, which can then be confirmed to check issuer (see e.g., FIG. 8).

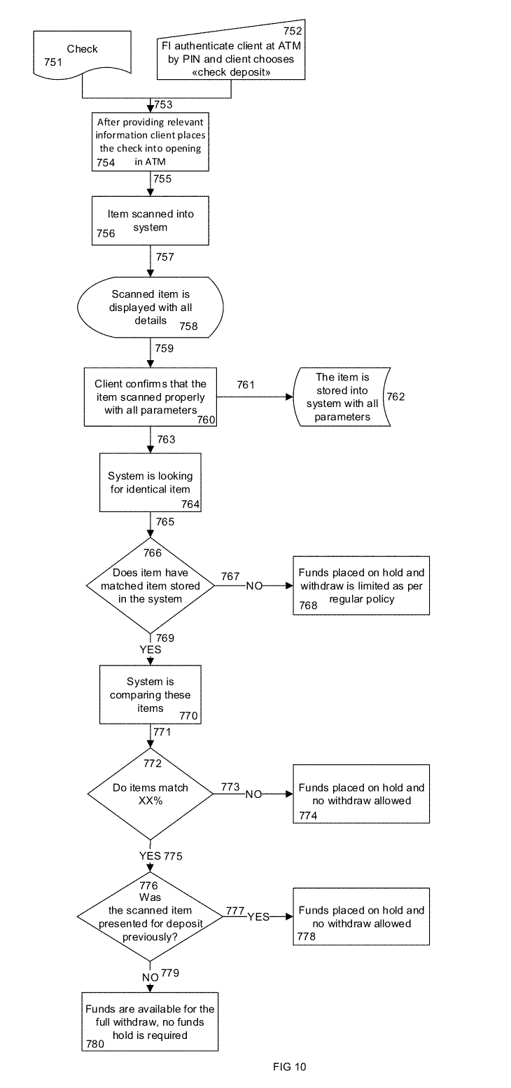

The systems and methods described herein, can operate in combination when the second data access module is an automated teller machine (ATM). As illustrated in FIG. 10, As illustrated, an end user (e.g., client) 752, e.g., a bearer of paper financial instrument 751 client can be authenticated as a client at an ATM by PIN. Client 752 can choose check deposit, in the ATM (see e.g., FIG. 10). After providing relevant information client scans the paper financial instrument (e.g., business check for a salary) using the ATM 752, and capture the second image 752 of the paper financial instrument 751. At which point, the scanned second image of paper financial instrument 751 is uploaded (e.g., through WAN network) to the ASP's system 754, using the data processing module, in combination with the image processing module, the second image of paper financial instrument 751 is partitioned to a plurality of fields as described herein, and the data is displayed 758 to client 752. Similar to the issuing process in the first data access module, client 752 (e.g., employee), can confirm whether or not the second image of paper financial instrument 751 was captured properly 760 (in other words, verifying the second image and then validating it). Once confirmed, the scanned second image and its partitioned fields with their unique identification number (UID) are uploaded to, and stored on the ASP's server for comparison and authentication purposes 762. Using UID, the ASP's system, utilizing the data processing module, the ASP's system can search 764 for a verified and validated matching image of a paper financial check instrument (e.g., 751, see e.g., FIG. 10).

Once the ASP's data processing module, completes the search, various sequential decision points can be employed to authenticate the second paper financial instrument 751. For example, the system queries whether or not the image and partitioned fields matches any image or partitioned fields stored on the data processing modules' memory 766. If not, the system can display a message that no matching paper item was found place the funds on hold, limiting withdrawal to the ATM's operator regular policy 768. If however, a match does exist and following a comparison by the data processing module 769, whether or not the plurality of fields identified and partitioned in the first image are identical to the plurality of fields identified and partitioned in the second image 751, else, the system can display a message that no identical match was found, place the funds on hold, and prohibiting withdrawal of any funds from the ATM 774.

If identical match is found however, the system queries whether or not the first image (see FIG. 6, 553) has already been authenticated/verified 776 by another client 752 at another location (e.g., second data access point, or ATM) and has therefore been paid to the holder. In other words, providing at least a reasonable evaluation and/or warning as to whether or not the financial instrument being verified for authentication can be deposited twice. If the item has been verified by a second data access module or ATM, the system can be configured to display a message to that effect, place the funds on hold, and prohibiting withdrawal of any funds from the ATM 778, else, the system can display a message that paper item 500 is authentic allowing immediate access to funds without any hold time 514.

As indicated, backend management server can be configured to search the database (e.g., memory of the first data access and second data access modules) for matches. As per definitions above, the system can be configured to also log the financial institution and its branch that searches for an item. The verification log can register the UID of the scanning Customer Service Representative, date, time, bank, transit number, and address of the institution. As such, if an item is scanned at a second or third location, “The check has been presented previously” alert message can accordingly be shown to advise the depositing branch of a possible fraud attempt.

For example, in issuing a draft, certified check or money order; standard bank protocols and procedures can be followed, whereby a bank employee prepares a financial instrument and obtains all necessary authorizing signatures. Prior to providing the customer with the item(s), the following steps should be taken: the bank employee can log into a station (see e.g., FIG. 3), where the set of executable instructions or software, residing on backend management server can be executed. The employee can then place item(s) into the scanner and selects “Scan” on the screen through that software, passing the item through the scanner. The system (e.g., backend management and content server using, e.g., the image processing module in electronic communication with the processor executing the set of instructions implemented by the software) captures the image and partitions the image to the relevant parameters of the item, and stores them on the secure (management/content) server. The system can then display the scanned item with, for example, an identified amount for confirmation. The bank employee can then approve the image, amount and item details, at which point, a confirmation message can be displayed (see e.g., monitor 321, FIG. 3), with a unique confirmation number, following which, the employee can issue the draft. In addition, the employee may print this confirmation message.

Returning now to FIG. 8, for all deposits types (in other words, those performed by a second user (or consecutive user) on a second client device (or second and consecutive network node); when a bank representative 653 is presented with item(s) 651, she/he will scan the item 651 using the system for authentication. As illustrated, Employee 653 logs 654 into the station where it is in electronic communication with software residing on management server is executed. It is noted, that steps 658-661 all take place on the server side of the system, while steps 654-657 are performed on the second client side by the second user. The employee can place item 651 into the scanner and clicks “Verify” button on the software 657, passing item 651 through the scanner. The system (e.g. comprising backend content/management server) captures check image 651 the second image and all relevant parameters of the item 651 and looks for a matching item in the database 669. If no matching item has been found, or there is a probability that the item has been altered, the system will display and/or print the appropriate message 681. If the matched item has been found in the database 684 and there is no evidence that this item has been previously scanned, the system can be configured to display and/or print an approval message 687. If the matched item has been found in the database, but this item has already been scanned for verification by another branch or financial institution, the system can be configured to display 691 and/or print the appropriate message (e.g., indicating the check has been previously presented), as well as send various alerts to stake holder parties.

The bank representative can print confirmation and follow standard protocol at the bank for a deposit (or other action if item is fraudulent or altered). The above mentioned process, follows the same logic and steps if the item is presented for deposit by the customer via mobile device (captured via camera), home scanner or ATM machine as outlined in step 655.

Returning to FIG. 5, illustrating circumstances where a bank representative 502 is presented with item(s) 501, she/he will scan the item 504 using the system for authentication. As illustrated, Employee 502 logs into the station where the system software is executed as indicated hereinabove. The employee can place item 501 into the scanner and clicks “Verify” button on the system software 504, passing item 501 through the scanner. The system (comprising backend content/management server 300, see e.g., FIG. 3) captures 506 the second image and all relevant parameters of the item 508 and looks for a matching item in the database 517. If no matching item has been found, or there is a probability that the item has been altered, the system will display and/or print the appropriate message 521. If the matched item has been found in the database 519 and there is no evidence that this item has been previously validated, the system can be configured to display and/or print an approval message 535. If the matched item has been found in the database, but this item has already been scanned for verification by another branch or financial institution, the system can be configured to display 539 and/or print the appropriate message 541, as well as send various alerts to stake holder parties. The bank representative can print confirmation and follow standard protocol at the bank for a deposit (or other action if item is fraudulent or altered).

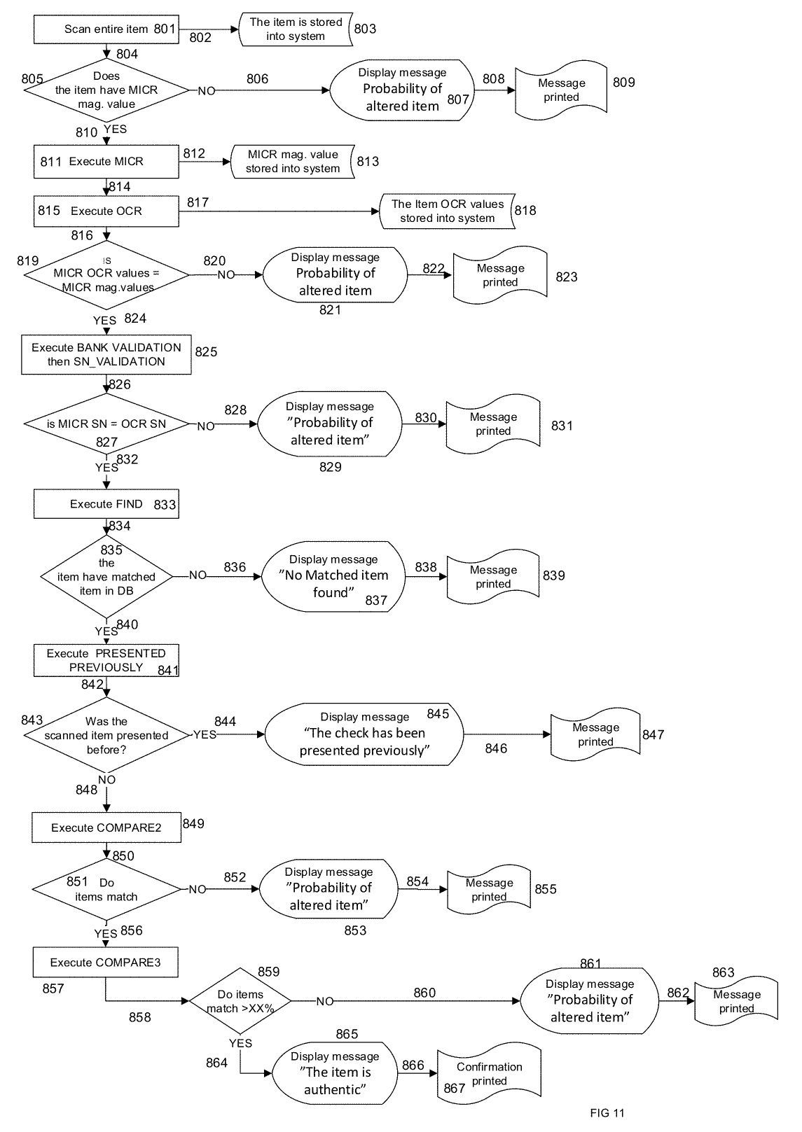

In an example for an algorithm for authenticating a paper financial instruments (see e.g., FIG. 11) by an issuing institution:
Scan entire item 801
MICR
Scan MICR code (section 2) with MICR reader 805
If MICR exists: 810
Read MICR magnetic values 811, Item Serial Number, Financial Institution (FI) code (Section 1) and transit number (section 14)
Store them into database 813
Go to OCR 815
If no MICR exists: 806
Display message ‘Probability of altered item’ 807
OCR (sections 1-14 store in database)
Apply correct form template based on FI code from MICR reading and additional logic for OCR decoding
Read individual OCR values and store data in database 818.
Compare MICR magnetic values with MICR OCR values (section 2)
If MICR=OCR 825
Go to BANK VALIDATION 825
If MICR≠OCR 820
Display message ‘Probability of altered item’ 821
BANK VALIDATION 825
Get transit number from MICR reading (section 14)
Locate bank branch address based on transit number within pre-populated database Compare address in pre populated database to OCR value in section 10
If values match,
Go to SN_VALIDATION 825
If they do not match,
Display message ‘Probability of altered item’ 829
SN_VALIDATION 825
GetSN number from MICR reading
Compare to OCR SN value in section 4
If values match 832,
Go to FIND 833
If do not match 828,
Display message ‘Probability of altered item’ 829
FIND 833
Search database for matching first image based on unique identification (UID) (MICR digits section 2) for comparison purposes;
Does item have match stored in the system? 835
If YES 840
Go to PRESENTED_PREVIOUSLY 841
If NO 836
Display message ‘No Matched item found’ 837
PRESENTED_PREVIOUSLY 841 Check if this item has been validated already by another FI 843;
If YES, 844 then
Flag additional attempt for validation (with time stamp and transit number) Display message ‘The item was validated already’ 845
If NO 848, then
Flag attempt for validation.log the time stamp and transit number to database.
Go to step COMPARE2 849
COMPARE2 849
Compare OCR values (sections 810, 814) retrieved value to value.
If match 856
Go to COMPARE3 857
If no match 852
Display message ‘Probability of altered item’ 853
COMPARE3 857
MICR data including digits, hand written values and signatures from originally issued item (e.g., first image) and validated item should be compared as image to image (similar to signature comparison).
If match 864
Display message ‘Item is authentic’ 865
Print confirmation 867
If no match 860
   Display message ‘Probability of altered item’ 861

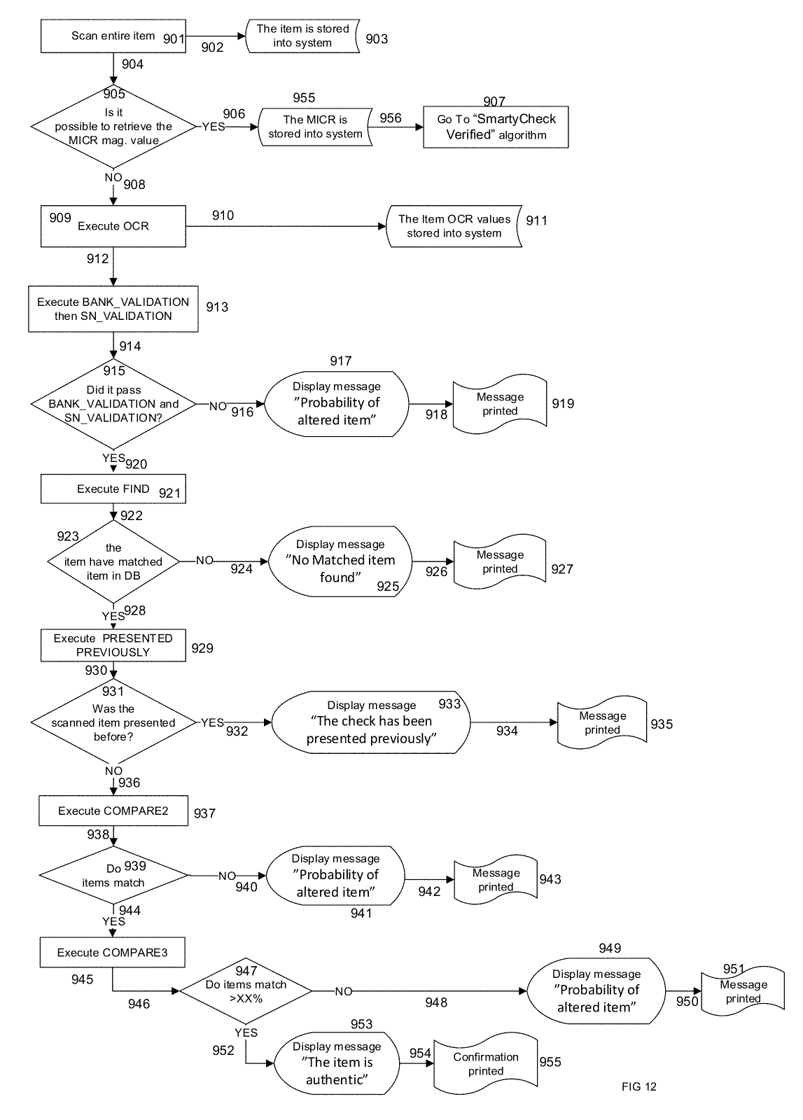

In an example for an algorithm for authenticating a paper financial instruments (see e.g., FIG. 12) by any client except of bank validating draft or other guarantied checks:
Scan entire item 901
MICR
Scan MICR code (section 2) with MICR reader
If scanning performed by check scanner and it is possible to retrieve MICR magnetic values: 905
Read MICR magnetic values, Item Serial Number, Financial Institution (FI) code and transit number
Store them into database 955
Go to SmartyCheck Verified algorithm for authenticating drafts and other guarantied checks. 907
If no MICR exists: 908
Go to OCR 909
OCR
Apply correct form template based on FI code from MICR/OCR reading and additional logic for OCR decoding
Using OCR, read individual sections and store their values in database 911
BANK VALIDATION 913
Get transit number from OCR reading of MICR
Locate bank branch address based on transit number within pre-populated database
Compare address in pre populated database to OCR value in section 10
If values match,
Go to SN_VALIDATION 913
If they do not match,
Display message ‘Probability of altered item’ 917
SN_VALIDATION 913
Get SN number from OCR
Compare to OCR SN value 913
If values match,
Go to FIND 920
If do not match, 916
Display message ‘Probability of altered item’ 917
FIND 921
Search database for matching image based on UID (digits section 2) for comparison purposes;
Does item have match stored in the system? 923
If YES 928
Go to PRESENTED_PREVIOUSLY 929
If NO 924
Display message ‘No Matched item found’ 925
PRESENTED_PREVIOUSLY 929
Check if this item has been presented before by another FI; 931
If YES, then 932
Flag additional attempt for validation (with time stamp and transit number)
Display message ‘The item was validated already’ 933
If NO, then 936
Flag attempt for validation. log the time stamp and transit number to database.
Go to step COMPARE2 937
COMPARE2 937
Compare OCR values (sections 3, 5) retrieved value to value 939.
If match 944
Go to COMPARE3 945
If no match 940
Display message ‘Probability of altered item’ 941
COMPARE3 945
digits, hand written values and signatures from originally issued item and validated item should be compared as image to image (similar to signature comparison). 947
If match 952
Display message ‘Item is authentic’ 953
Print confirmation 955
If no match 948
   Display message ‘Probability of altered item’ 949

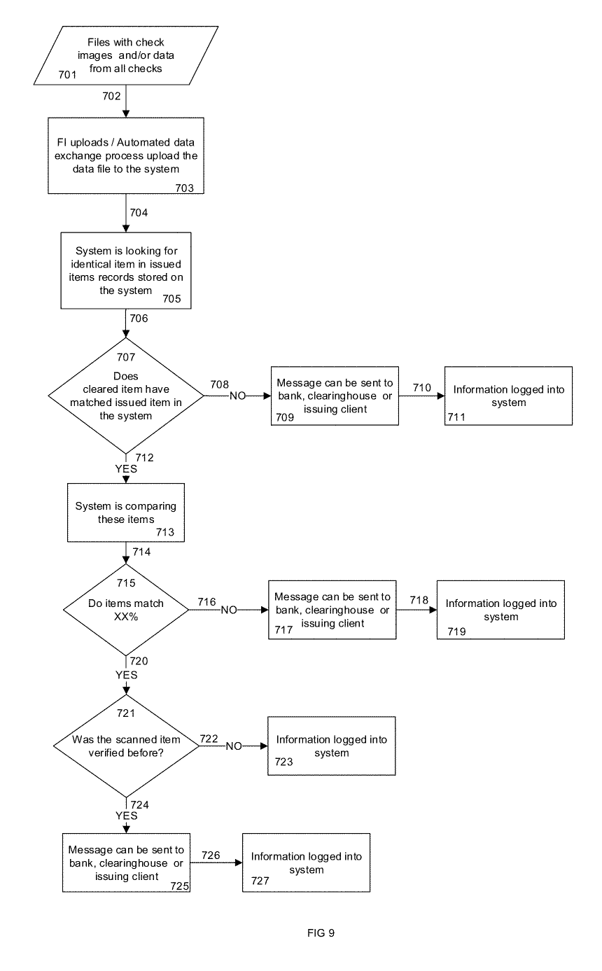

FIG. 9 captures the process flow of a non-participating financial institutions (credit union, bank, alike). It is understood that not every FI would want to offer their clients the full solution provided by the systems and methods described herein. However, it is also expected that FIs are all faced with similar fraud and would most likely join forces even as competitors to battle this phenomena. Non Participating FI flow is designed to help participating FIs in fighting fraud. The request from Non Participating FI(s) is to upload, via secure channels, all images of accepted and negotiated checks into the authentication system described herein, in order for others to maintain a record and facilitation of authenticity verification as needed. Although non participant FI may not get the full benefit of authenticity verification of the systems and methods described herein, their contribution is directly and in directly benefiting them too by reducing overall fraud in the check clearing system.

Any non-participating FI can upload images of checks 701 or data fields values as a file of all accepted deposits and negotiated items for that business day into the system 703. The system compares parsed fields' data values from all uploaded images from that FI or data files against parsed fields' data values from all “original” images and looking for a match 705. Upon finding a matching image, authenticity algorithm is performed 713. If no matching item has been found, or there is a probability that the item has been altered 707, the system can send a message to bank, clearinghouse or issuing client 709. If the matched item has been found in the database 707 and there is no evidence that this item has been previously scanned, the system can be configured to log message 723. If the matched item has been found in the database, but this item has already been scanned for verification by another branch or financial institution, the system can be configured to send message 725 and log the information 727. Information is logged into the system at all instances as per 711,719,723 and 727.

FIG. 1 shows the architecture of system 100. System 100 can have various operational elements: a first Data Access Terminal (DAT) 150 or module, a second data access terminal or module 160; a business remote user station 140 (see e.g., FIG. 6), a backend Authentication Service Provider content and management server 101, Wide Area Network cloud provider 130 in electronic communication with first Data Access Terminal (DAT) 150 via, for example, router 151; with second data access terminal or module 160 via, for example, network switch or router 161; with remote user station 140 via for example router (or other network switch) 141 or directly using mobile communication device 110; and with backend Authentication Service Provider content and management server 101 via, for example, router 102. System 100 could also use other software development standard, other system deployment standards and other reliability standards as long as adherence to these alternative standards provides the security, availability and reliability required by mission critical financial applications.

In an embodiment, the image processing module used in the systems, programs and methods for authenticating paper financial instruments described herein can comprise: an optical character recognition (OCR) subsystem, an intelligent character recognition (ICR) subsystem, an image mapping comparison subsystem, a magnetic ink character recognition (MICR) subsystem, or a combination of imaging subsystems comprising two or more of the foregoing.

Neural-network ICR engines can be trained from scratch by exposing the subsystem to a character training set consisting of thousands of discreet images of characters that point to their ASCII values. The ICR engine can then be required to recognize a new set of characters (e.g., in the financial instrument scanned) that are not part of the training set. Character images that are incorrectly recognized by the engine are as simulated into the original training set and the engine is retrained on the new set. This process can be repeated until the accuracy of the engine meets certain predefined standards on arbitrary collections of real world image data, which standards are based upon comparable performance by professional data entry personnel (e.g., >98% accuracy). For example, there are a number of character recognition engines that could be employed by the systems and methods described herein. The ICR engines that could currently be used by the systems and methods described herein can be, for example, FieldScript and CheckScript, v2.2. by Parascript (Colorado Springs, Colo.) for LAR; Quickstrokes v2.4, by Mitek (San Diego, Calif.); OrboCAR v2.13, by OrboGraph (Israel) for CAR (character amount recognition), and Wordscan Plus, 1998 edition, by Caere for OCR of machine print.

Likewise, image mapping comparison refers to both aggregate image maps as well as image maps corresponding to true full backup images (e.g., stored in the memory of the first data access module), or incremental backup images. For example, a given aggregate image map of the scanned financial check instrument (FCI) may include pointers to any desired collection of entries within other image maps, including one or more other aggregate image maps (some of whose entries may point to entries within one or more other aggregate image maps as well as image maps corresponding directly to backup images (for example, already verified and authenticated FCI's). Thus, when following a pointer from a given entry of an aggregate image map to a corresponding data block, multiple intermediate entries at different layers within a hierarchy of image maps may be encountered. In certain embodiments, when a choice may exist between using multi-layer aggregate image maps or using the underlying full and incremental image maps when establishing a requested aggregate image, a backup image processing processor manager may be configured to allow a user to indicate a preference between the possible choices. For example, a user may specify a maximum or desired number of layers or a desired image map hierarchy structure for a requested aggregate image map.

Further and as part of the recognition process, a MICR magnetic read head can be used to read the information printed on the FCI. Typically, approaches to MICR generally involve the step of determining peak information for a waveform generated by the magnetic read head. This peak information can typically include information regarding the amount of time between the peaks of each character. Knowledge of the velocity of the document (and thus, the character contained therein) allows this time information to be converted into distance information, which can be compared to each MICR character and their peak profiles as contained for example, in the ANS X9.27-2000 “Print and Test Specifications for Magnetic Ink Printing (MICR)” as promulgated by the American National Standards Institute.

In an embodiment, the systems described herein, are used in the methods provided herein. Accordingly, provided herein is a method of authenticating a financial check instrument, comprising: receiving a first image and/or data file with images and or/data per check item corresponding to a first check from a first data module; receiving a second image corresponding to a second check from a temporospatially separated second data access module; using a processing module residing on a backend management server, partitioning the first image into a plurality of fields; using the processing module residing on the backend management server, partitioning the second image into the same plurality of fields; using the processing module residing on the backend management server, comparing the plurality of fields of the second image to the plurality of fields of the first check image; using the processing module residing on the backend management server, determining the degree of similarity between the second image and the first image; and if the degree of similarity is above a predetermined threshold, providing an authentication indicia to an end user of the second data access module.

As illustrated in the algorithm provided hereinabove (and referring to FIG. 12), the system, in general, there is no “overlay”, virtual or otherwise, of the images and similarity threshold can be selectibly assigned (in other words, capable of being defined by the second, third and consecutive users without affecting other processes), to each parsed field. For example, the degree of similarity assigned to the signature, the MICR value, the sum value can have a different threshold value than date, bank names, etc.

Furthermore, the term “temporospatially separated” as used herein, refers to circumstances where the first data access module has a different private and public IP addresses than the private and public IP address of the second (or third and consecutive) data access module(s).

As will be appreciated by one of ordinary skill in the art in view of this disclosure, the disclosed technology may include and/or be embodied as an apparatus (including, for example, a system, machine, device, computer program product, and/or the like), as a method (including, for example, a business method, computer-implemented process, and/or the like), or as any combination of the foregoing. Accordingly, certain embodiments disclosed herein may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments disclosed herein may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function

Accordingly and in yet another embodiment, provided herein is a non-transitory processor-readable medium residing on a backend management server, comprising a set of executable instructions for authenticating a check, said executable instructions are configured for causing a processor to: receive a first image corresponding to a first financial instrument from a first data module; receive a second image corresponding to a second financial instrument from a temporospatially separated second data access module; partition the first image into a plurality of fields; partition the second image into the same plurality of fields; compare the plurality of fields of the second image to the plurality of fields of the first check image; determine the degree of similarity between the first image and the second image; and if the degree of similarity is above a predetermined threshold value, provide an authentication indicia to the second data access module, otherwise provide an indicia of lack of authenticity.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, .NET, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages.

Some embodiments disclosed herein are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

Further, the one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment disclosed herein.

The terms “customer”, “consumer” and formatives thereof as utilized herein refer to any party desiring to initiate interaction with an information/support service accessible by the methods and systems described herein and likewise is meant to include any individual, party, entity, or combination thereof that queries base level data and derived information from the systems and methods described, and may be used interchangeably with “user,” or “end-user”.

The system described herein, used to implement the methods described using the set of instructions implemented by the processor can also comprise: a plurality of heterogeneous hardware and software components (e.g., wired/wireless communications hardware/software) configured to implement the methods described herein thus providing one or more services. An additional Web Exchange module can comprise, for example, a service provider configured to provide access to the one or more services provided by the Web Exchange module via a network to one or more service requesters configured to access the one or more services via the service provider over the network. (See e.g., FIGS. 1,2,3)

The Web Exchange system can be configured and implemented according to a vendor-independent Web Cloud Service 130 architecture generated according to a structured design process for designing and generating vendor-independent Web Could Service architectures such that, for example, the plurality of heterogeneous hardware components are organized according to two or more tiers and two or more layers of the Web Exchange architecture, and/or one or more Web Exchanges design patterns are applied to the Web Exchange architecture, such that each design pattern models a particular structure that is applicable to the Web Exchange. For example, one Web Exchange design pattern/architecture may be associated with providing services associated with individuals using the systems and methods described herein, while a second Web Exchange design pattern/architecture may be associated with providing other services associated with the systems and methods described herein.

An end- user interface component, with the end-user and/or user-specific data having an internal content representation that correlates to an external appearance in a plurality of content option can be provided. The end-user (e.g., business, government, retail customer, bank employee) interface and/or user-specific data server can incorporate the requested data retrieved from the ASP's main server, into a current view in the end-users' display means. The Business Issuer data server can for example, be coupled to the end-user dedicated interface. The end-user interface can be configured to retrieve requested data incorporated into the ASP's database's server and to display the requested data retrieved as one or more content items.

The terms “content and/or backend management server” or “user specific data server”, when used, refer to a back-end hardware and software product that is used to manage content. Likewise, the term “in communication with” refers in an embodiment, to any coupling, connection, or interaction using electrical signals to exchange information or data, using any system, hardware, software, protocol, or format.

The terms “first,” “second,” and the like, herein do not denote any order, quantity, or importance, but rather are used to denote one element or step from another. The terms “a”, “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the item(s) includes one or more item). For example, a “first” image can be the original intended check at time of issuance prior to giving to intended payee (e.g., by the business issuer), while “second” image can refer to the image scanned by payee during deposit, or scanned by a check cashing institution.

Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

Communication among the system components can be achieved over a plurality of communication paths. The term “communication path” refers to a communication format that has multiple channels. For example, contemplated communication paths include radio frequency bands, including NOAA frequency band, EAS frequency band, various UHF and/or VHF frequency bands, microwave and infrared frequency bands, frequency bands used for cellular communication, cable and/or satellite TV transmission systems, optical network systems, and/or high-speed digital data transmission systems. The term “channel” can refer to a specific modality within the communication path. For example, where the communication path is cellular communication (e.g., 824-849 MHz, 869-894 MHz, or 1850-1990 MHz), the channel may be a single frequency, or a spectrum of multiple frequencies (e.g., CDMA signal) within that communication path. Likewise, where the communication path is a fiber optic cable system, channels will correspond to high-speed (e.g., >1.0 Mb/s) digital data transmission system, a channel may be a network address.

Also, the term “non-transitory computer-readable medium” may include a single medium or multiple media (e.g., a centralized or distributed database, or associated caches and servers) that store the one or more instructions. The term “non-transitory computer-readable medium” shall also be taken to include any tangible medium that is capable of storing, encoding, or carrying instructions for execution by the machine and that cause the machine to perform any one or more of the methodologies disclosed herein, or that is capable of storing, encoding, or carrying data structures used by or associated with such instructions. The term “non-transitory computer-readable medium” shall accordingly be taken to include, but not be limited to, solid-state memories, and optical and magnetic media. Specific examples of non-transitory machine-readable media include non-volatile memory, including by way of exemplary semiconductor memory devices (e.g., EPROM, EEPROM, and flash memory devices); magnetic disks such as internal hard disks and removable disks; magneto-optical disks; and CD-ROM and DVD-ROM disks. The term “disk” as used herein refers to a storage disk or other memory that can store data for a computer system.

The software, information and/or data may further be transmitted or received over a global communications network using a transmission medium via a network interface device utilizing (see e.g., router 141, FIG. 1) any one of a number of well-known transfer protocols (e.g., HTTP). Examples of communication networks include a local area network (LAN), a wide area network (WAN), the Internet, mobile telephone networks, Plain Old Telephone (POTS) networks, and wireless data networks (e.g., LTE, WiFi and WiMax networks). The term “transmission medium” shall be taken to include any intangible medium that is capable of storing, encoding, or carrying instructions for execution by the machine (e.g., a computer), and includes digital or analog communications signals or other intangible medium to facilitate communication of such software. In an embodiment, the methods described herein make use of the systems and non-transitory, computer-readable medium provided herein.

For example, a machine in the exemplary form of a computer system within which the instructions, for causing the machine to perform any one or more of the methods provided herein, may be executed. The machine can for example operate as a standalone device (e.g., SMB PDA 113, FIG. 1) or may be connected (e.g., networked) to other machines (e.g., ATMs 153). In a networked deployment, the machine may operate in the capacity of a server or a client machine in server-client network environment, or as a peer machine in a peer-to-peer (or distributed) network environment (e.g., when the first and second data access modules are in the same institution but in different locations). The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methods disclosed herein.

In addition, the program may be further configured to execute commands directed to initiating communication between a user (e.g., the second data access module) and the ASP's database over a communication network configured to upload information from the second data access module user and the non-transitory, computer readable medium; and initiating communication between the user server(s). In initiating communication, the command can execute direct transmission and reception of signals without connecting through any base stations or servers by, for example, wireless signal transmission means such as electric waves or through cables.

Moreover, plural instances may be provided for resources, operations, or structures described herein as a single instance. Additionally, boundaries between various resources, operations, modules, engines, and data stores are somewhat arbitrary, and particular operations are illustrated (see e.g., FIG. 1) in a context of a specific illustrative configurations. Other allocations of functionality are envisioned and may fall within a scope of various embodiments disclosed herein. In general, structures and functionality presented as separate resources in the exemplary configurations may be implemented as a combined structure or resource. Similarly, structures and functionality presented as a single resource may be implemented as separate resources.

?

While in the foregoing specification the methods and systems have been described in relation to certain embodiments, and many details are set forth for purpose of illustration, it will be apparent to those skilled in the art that the disclosure is susceptible to additional embodiments and that certain of the details described in this specification and as are more fully delineated in the following claims can be varied considerably without departing from the basic principles of this invention.

We claim:

1. A system for authentication and verification of a financial check instrument comprising:
a. a first data access module comprising at least one imaging subsystem;
b. a second data access module comprising at least one imaging subsystem, wherein the second data access module is temporospatially separate from the first data access module;
c. a backend management server comprising: an image processing module, a data processing module, a memory; and a processor in electronic communication with the memory, the first data access module, the second data access module, the data processing module and the image processing module, wherein the processor is configured to:
i. receive a first image corresponding to a first financial check instrument from the first data module;
ii. receive a second image corresponding to the second data access module;
iii. partition the first image into a plurality of fields;
iv. partition the second image into the same plurality of fields;
v. compare the plurality of fields of the second image to the plurality of fields of the first image;
vi. determine the degree of similarity between the first image and the second image; and
vii. if the degree of similarity is above a predetermined threshold value, provide an authentication indicia to the second data access module, else provide an indicia of a lack of authenticity.

2. The system of claim 1, wherein the system further comprises a communication network in electronic communication with the first data access module, the second data access module, and the backend management server.

3. The system of claim 2, wherein the image processing module comprises: an optical character recognition (OCR) subsystem, an intelligent character recognition (ICR) subsystem, an image mapping comparison subsystem, a magnetic ink character recognition (MICR) subsystem, or a combination of imaging subsystems comprising two or more of the foregoing.

4. The system of any claim 1, wherein the check is a money order, a draft, a certified check, a cashier check, a governmental refund check, a government payroll check, a social security check, a welfare check, a pension check, a retail individual check, or a business check.

5. The system of claim 2, wherein the communication network is a wide area network, a cellular network, a local area network, a wireless network, or a combination comprising one or more of the foregoing.

6. The system of claim 1, wherein the first data access module and/or the second data access module, is an issuer bank, an issuing small to medium business, an automatic teller machine, a governmental entity, or a large business enterprise.

7. The system of claim 4, wherein the plurality of fields partitioned by the processor in the first and second images is a magnetic ink character recognition (MICR) line, Overall image as a whole, Date, Serial number, All signatures, Payee Name, Amount CAR/LAR, Issuing bank and branch details, Protectograph and magnetic ink values, Hand written or printed item value.

8. The system of claim 1, wherein the authentication indicia is in the form of a message.

9. A method of authenticating a paper financial instrument, comprising:
a. receiving, by a backend management server, a first image corresponding to a first check from a first data access module, wherein the first data access module is in electronic communication with the backend management server;
b. receiving by the backend management server a second image corresponding to a second paper financial instrument from a second data access module, wherein the second data access module is temposrospatially separated from the first data access module and is in electronic communication with the backend management server;
c. using the backend management server, partitioning the first image into a plurality of fields;
d. using the backend management server, partitioning the second image into the same plurality of fields;
e. using the backend management server, comparing the plurality of fields of the second image to the plurality of fields of the first check image in order to determine a level of similarity between the second image and the first image;
f. using the backend management server, determining the degree of similarity between the second image and the first image; and
g. if the degree of similarity is above a predetermined threshold, providing an authentication indicia to a user associated with the second data access module, else providing the user associated with the second data access module with an indicia of a lack of authenticity.

10. The method of claim 9, wherein partitioning the first and/or the second images of the paper financial instrument comprises using an image processing module residing on the backend management server, the module comprising an optical character recognition (OCR) subsystem, an intelligent character recognition (ICR) subsystem, an image mapping comparison subsystem, a magnetic ink character recognition (MICR) subsystem, or a combination of imaging subsystems comprising two or more of the foregoing.

11. The method of claim 10, wherein the check is a money order, a draft, a certified check, a cashier check, a governmental refund check, a government payroll check, a social security check, a welfare check, a pension check, a retail individual check, or a business check.

12. The method of claim 11, wherein the predetermined threshold of the degree of similarity between the second image and the first image in the step of providing the authentication indicia is equal to or greater than 98% similarity, or is performed by professional data entry personnel.

13. The method of claim 12, wherein the plurality of fields partitioned by the image processing module residing on the backend management server, in the first and/or second images in the steps of partitioning, is a magnetic ink character recognition (MICR) line, Overall image as a whole, Date, Serial number, All signatures, Payee Name, courtesy amount recognition (CAR), legal amount recognition (LAR), Issuing bank and branch details, Protectograph and magnetic ink values, Hand written value, or printed item value.

14. The method of claim 13, wherein the first data access module and/or the second data access module, is an issuer bank, an issuing small to medium business, an automatic teller machine, a governmental entity, or a large business enterprise.

15. The method of claim 14, wherein the steps of receiving the first image corresponding to the first check from the first data module by the backend management server, receiving the second image corresponding to the second check from the second data access module, and providing the authentication indicia to the user associated with second data access module comprise using a wide area network, a cellular network, a local area network, a wireless network, or a combination comprising one or more of the foregoing.

16. The method of claim 9, wherein the authentication indicia is in the form of a message.

17. A non-transitory computer-readable medium comprising computer-readable instructions for authenticating a check, said computer-readable instructions resident on a backend management server, configured for causing a processor to:
a. receive a first image corresponding to a first check from a first data module, wherein the first data access module is in electronic communication with the backend management server;
b. receive a second image corresponding to a second check from a second data access module, wherein the second data access module is temposrospatially separated from the first data access module and is in electronic communication with the backend management server;
c. partition the first image into a plurality of fields;
d. partition the second image into the same plurality of fields;
e. compare the plurality of fields of the second check image to the plurality of fields of the first check image in order to determine a level of similarity between the second image and the first image;
f. determine the degree of similarity between the first check image and the second check image; and
g. if the degree of similarity between the two check images is above a predetermined threshold value, provide an authentication indicia to a user associated with the second data access module, else provide the user with an indicia of a lack of authenticity.

18. The non-transitory computer-readable medium of claim 17, wherein the computer-readable instructions are further executed by the processor to partition the first and/or the second images of the paper financial instrument comprises using an image processing module residing on the backend management server, the module comprising an optical character recognition (OCR) subsystem, an intelligent character recognition (ICR) subsystem, an image mapping comparison subsystem, a magnetic ink character recognition (MICR) subsystem, or a combination of imaging subsystems comprising two or more of the foregoing.

19. The non-transitory computer-readable medium of claim 18, wherein the plurality of fields partitioned in the first and second check images, is a magnetic ink character recognition (MICR) line, Overall image as a whole, Date, Serial number, All signatures, Payee Name, courtesy amount recognition (CAR), legal amount recognition (LAR), Issuing bank and branch details, Protectograph and magnetic ink values, Hand written value, or printed item value.

20. The non-transitory computer-readable medium of claim 19, wherein the first data access module and/or the second data access module, is associated with an issuer bank, an issuing small to medium business, an automatic teller machine, or a large business enterprise.

21. The non-transitory computer-readable medium of claim 17, wherein the computer-readable instructions are further configured to provide the authentication indicia if the determined similarity between the second image and the second image is equal to or greater than 98% similarity, or is performed by professional data entry personnel.

22. The non-transitory computer-readable medium of claim 17, wherein the computer-readable instructions are further configured to provide a user associated with the first data access module with an indicia validating the first check image.

23. The non-transitory computer-readable medium of claim 17, wherein the computer-readable instructions are further configured to provide a user associated with the first data access module, and/or the second data access module with the indicia in the form of a message.
